(19) United States
(12) Patent Application Publication
(10) Pub. No.: US 2008/0090685 A1
(43) Pub. Date: Apr. 17, 2008

(54) Deairing type hydraulic tensioner

(75) Inventors: Tsutomu Namie, Osaka (JP); Hiroshi Hashimoto, Osaka (JP)

Correspondence Address: HOWSON AND HOWSON, SUITE 210, 501 OFFICE CENTER DRIVE, FT WASHINGTON, PA, 19034, US

(73) Assignee: Tsubakimoto Chain Co., Osaka (JP)

(21) Appl. No.: 11/880,999

(22) Filed: Jul. 25, 2007

(30) Foreign Application Priority Data
Oct. 12, 2006 (JP) 2006-278985

(51) Int. Cl. F16H 7/08

(52) U.S. Cl. 474/110

(57) ABSTRACT

In a hydraulic tensioner comprising a tensioner body and a hollow plunger slidable in a plunger-receiving hole, a deairing check ball assembly comprises a check ball, a ball seat, a ball retainer and a check ball biasing spring arranged to bias the check ball away from the seat and toward a high pressure chamber formed by a plunger-receiving hole and the interior of the plunger. The deairing check ball assembly can be incorporated into the tensioner body or into the plunger.

This application claims priority on the basis of Japanese patent application 2006-278985 filed Oct. 12, 2006. The disclosure of Japanese application 2006-278985 is hereby incorporated by reference.

### FIELD OF THE INVENTION

This invention relates to a hydraulic tensioner for applying proper tension to a timing belt, a timing chain, or the like, in a vehicle engine.

### BACKGROUND OF THE INVENTION

A hydraulic tensioner including a ball-type check valve for blocking reverse flow of oil from the high pressure oil chamber of the tensioner has been widely used for maintaining proper tension in the timing belt or timing chain used to transmits rotation from the crankshaft to one or more camshafts in a vehicle engine.

A typical hydraulic tensioner 500, as shown in FIG. 6, includes a hollow, cylindrical, plunger 520, slidably protruding from a hole 511 formed in a body 510, a plunger biasing spring 530, in compression between the end wall of the hole 511 a front end wall of a hole 521 formed in the plunger. Spring 530 biases the plunger 520 in the protruding direction for engagement with a movable tensioner lever or guide on which the timing belt or timing chain slides. A check valve assembly 540, incorporated into the end of the tensioner body adjacent the bottom of hole 511, allows oil to flow under pressure into a high pressure oil chamber R formed by the hole 511 in the tensioner body and the hole 521 in the plunger, but blocks reverse flow of the oil.

FIG. 7 shows a known deairing hydraulic tensioner 600 comprising a hollow cylindrical plunger 620 slidably protruding from a plunger-receiving hole 611 formed in a tensioner body 610. A plunger-biasing spring 630 is disposed between the bottom of the plunger-receiving hole 611 and the bottom of the interior of the hole 621 formed inside the plunger 620. The spring biases the plunger 620 in the protruding direction. A deairing valve assembly 650 is provided for exhausting air that was mixed with oil in the high pressure oil chamber R, formed by hole 611 in the tensioner body and the hole 621 in the plunger. Air is exhausted through an exhaust vent 622 adjacent the outer end of the plunger through a deairing valve assembly 650 incorporated into the end of the interior of plunger. The deairing valve assembly 650 comprises a check valve, which blocks the outflow of the oil from the high pressure oil chamber R but releases air. The check valve comprises a ball 654, which cooperates with a cylindrical ball seat 653, and a retainer 652, which envelops the check ball while allowing the check ball to move freely within a limited range between a condition in which it is engaged with the ball seat, blocking flow, and a condition in which it is spaced from the ball seat to allow flow. The ball seat and the retainer are fitted together and held in a recess formed at the front end of the interior of the plunger. The deairing tensioner of FIG. 7 is described in British patent application GB 2429393, published May 24, 2006.

In the conventional hydraulic tensioner 500 shown in FIG. 6, the check valve assembly 540 can block reverse flow of oil from the high pressure oil chamber R. However, air can become mixed with the oil in the high pressure oil chamber R. Since air is compressible, the presence of air, in the high pressure oil chamber impairs the damping action of the tensioner. Consequently noise can be generated by backlash in the timing chain upon starting of the engine.

The improved hydraulic tensioner 600, shown in FIG. 7, provides for discharge of air that has become mixed with oil in the high pressure oil chamber. Air is discharged by means of the deairing valve assembly 650 inside the plunger. However, if the time permitted for opening the check valve 651 is insufficient, the amount of air discharged for each reciprocation of the plunger is small, and a considerable amount of time is required to achieve complete discharge of air from the high pressure oil chamber. Consequently, even with the incorporation of the deairing valve of FIG. 7, the presence of air mixed with oil inside the tensioner can result in noise during engine start-up.

An object of this invention is to solve the aforementioned problems of the conventional hydraulic tensioner of FIG. 6 and the deairing type hydraulic tensioner of FIG. 7. More particularly, the deairing type hydraulic tensioner according to the invention incorporates a new deairing valve assembly, which can suppress backlash and vibration of timing chain on engine start-up, due to the influence of air in the high pressure oil chamber of the tensioner, and also maintain a high pressure condition in the high pressure oil chamber during engine operation.

### SUMMARY OF THE INVENTION

The deairing type hydraulic tensioner according to the invention comprises a tensioner body having a plunger-receiving hole formed therein, and a plunger. The plunger-receiving hole has an open end and a bottom. The plunger is slidably received in the plunger-receiving hole and protrudes therefrom through the open end in a protruding direction. The plunger has a hollow interior and an open end facing the bottom of the plunger-receiving hole. The plunger also has plunger bottom opposite from its open end. The hollow interior of the plunger and the plunger-receiving hole in the tensioner body together form a high pressure oil chamber. A biasing spring urges the plunger in the protruding direction. The tensioner is also provided with a deairing check valve assembly for exhausting air mixed with oil in the high pressure oil chamber to the exterior of the tensioner by flow in an outward direction. The deairing check valve assembly comprises a check ball, a ball seat having a hollow flow passage, the ball being engageable with the ball seat, by movement along said outward direction, to close the flow passage and thereby block outward flow of oil from the high pressure oil chamber. The check valve assembly also comprises a retainer, fitted to the ball seat, for limiting movement of the ball toward and away from the ball seat. A vent hole is provided in the ball seat at an end thereof remote from the ball, and a biasing spring, disposed within the flow passage of the ball seat between the vent hole and the ball and engaged with the ball, urges the check ball away from the ball seat.

In a first embodiment of the invention, the tensioner has an exhaust vent for release of air from the high pressure oil chamber, the exhaust vent being provided in the plunger adjacent the plunger bottom. The deairing check valve assembly is incorporated into the interior of the plunger adjacent the plunger bottom, and the vent hole in the ball seat is in communication with the exhaust vent.

In a second embodiment, the deairing check valve assembly is incorporated into the tensioner body.

The ball spring disposed in the hollow flow passage of the ball seat, biases the check ball valve toward its opened condition, and more effectively and smoothly exhausts air from the high pressure oil chamber, thereby maintaining high pressure in the oil chamber and reducing backlash noise on engine start-up.

### BRIEF DESCRIPTION OF THE DRAWINGS

FIG. 1 is a schematic front elevational view of a timing drive in a double overhead cam (DOHC) internal combustion engine, in which tension is applied to a timing chain by a deairing type hydraulic tensioner according to the invention;

FIG. 2a is a cross-sectional view of a deairing type hydraulic tensioner according to a first embodiment of the invention;

FIG. 2b is an enlarged cross-sectional view of a deairing check valve in the tensioner of FIG. 2a;

FIG. 3a is a sectional view of the deairing check valve showing the valve in its open state;

FIG. 3b is a sectional view of the deairing check valve showing the valve in its closed state;

FIG. 4a is a cross-sectional view of a deairing type hydraulic tensioner according to a second embodiment of the invention;

FIG. 4b is an enlarged cross-sectional view a deairing check valve in the tensioner of FIG. 4a;

FIG. 5a is a cross-sectional view showing another embodiment of a deairing check valve;

FIG. 5b is a cross-sectional view showing still another embodiment of a deairing check valve;

FIG. 6 is a cross-sectional view of a conventional hydraulic tensioner; and

FIG. 7 is a cross-sectional view of conventional deairing type hydraulic tensioner, illustrating the deairing operation thereof in an enlarged auxiliary view.

### DETAILED DESCRIPTION OF THE PREFERRED EMBODIMENTS

The deairing check valve according to the invention, in which the check ball is spring-biased away from its seat toward the high pressure oil chamber, can be incorporated into the plunger or body of any of various kinds of hydraulic tensioners, including hydraulic tensioners having ratchet mechanisms.

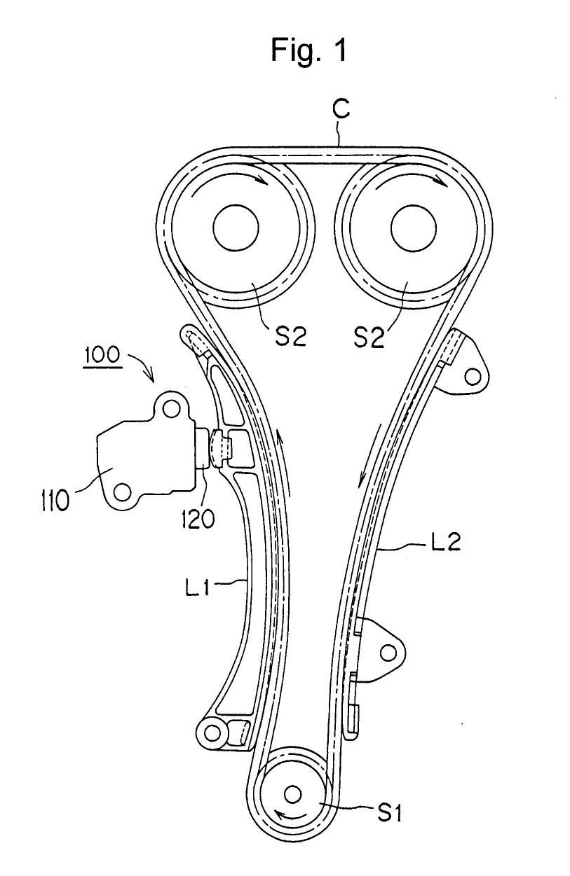

The deairing type hydraulic tensioner 100, shown in FIG. 1, is attached to an engine body adjacent the slack side of a timing chain C, arranged to transmit power from a driving sprocket S1 rotated by an engine crankshaft to a pair of driven sprockets S2 on the engine camshafts. A plunger 120 protrudes from the tensioner body 110 and engages a pivoted lever L1 on which the slack side of the chain slides. The plunger engages the lever at a location remote from the lever's pivot, causing the lever to press against the chain so that the lever applies tension to the chain. A fixed guide L2, which is also attached to an engine body, is in sliding engagement with the tension side of the timing chain. Arrows show the direction of rotation of the sprockets and the direction of travel of the timing chain.

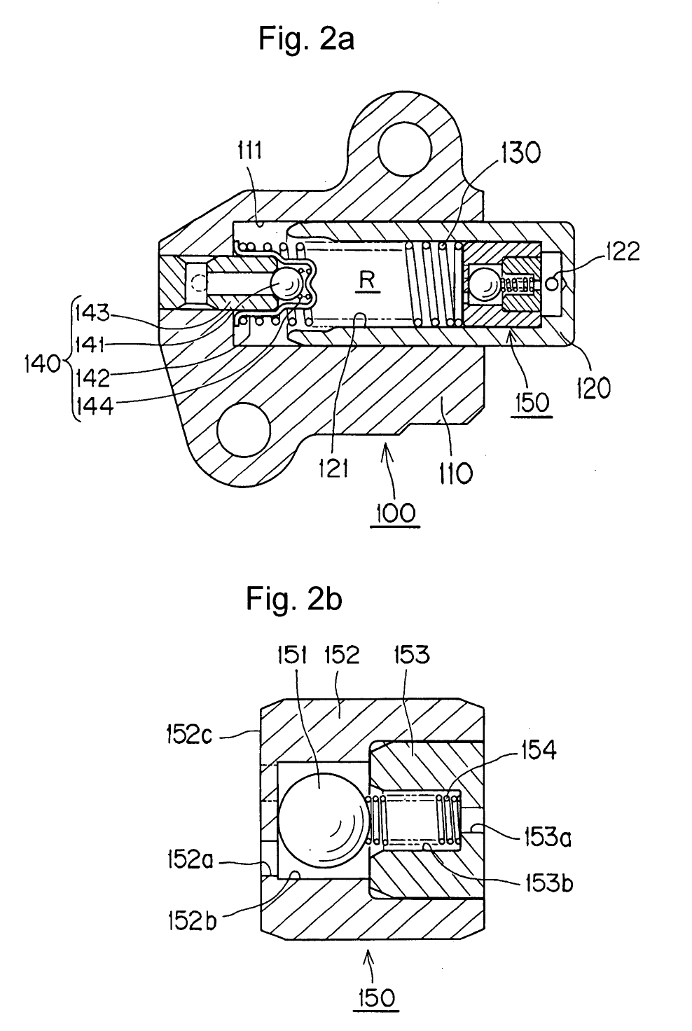

In the deairing type hydraulic tensioner 100, shown in FIG. 2a, a cylindrical plunger 120, having a hole 121 formed therein, fits slidably into a plunger-receiving hole 111 formed in a tensioner body 110. A high pressure oil chamber R is formed by the plunger-receiving hole 111 the hole 121 in the plunger. A plunger-biasing spring 130 biases the plunger 120 in the protruding direction.

A check valve assembly 140 is incorporated into the bottom of the plunger-receiving hole 111. The check valve assembly allows oil to flow into the high pressure oil chamber R but blocks reverse flow of oil from the high pressure oil chamber.

The check valve assembly 140 comprises a check ball 141, a metal retainer 142, which envelops the check ball, allowing the ball to move freely with in a limited range into and out of engagement with a cylindrical metal seat 143, which is fitted to the tensioner body and which has a passage for flow of oil into the high pressure oil chamber R from an oil supply. A biasing spring 144 biases the check ball 141 toward the ball seat 143. The check valve assembly 140 allows oil to flow into the high pressure oil chamber R from a source of oil under pressure, but blocks reverse flow of oil.

A deairing check valve assembly 150 is incorporated into the inside of the plunger adjacent the bottom of the hole 121 formed in the plunger, that is, adjacent the protruding end of the plunger. The deairing check valve exhausts air that becomes mixed with oil in the high pressure oil chamber R through an exhaust vent 122 formed adjacent the bottom of hole 121.

The enlargement of the deairing valve assembly 150 shown in FIG. 2b shows the check ball 151, which blocks outflow of oil from the high pressure oil chamber, a cylindrical metal seat 153, and a metal retainer 152, which envelops the check ball 151, allowing the check ball to move freely within a limited range toward and away from the seat in a guide hole 152b in the retainer. In this embodiment, the seat 153 is fitted in a recess formed in the retainer 152. The seat has a vent hole 153a, which communicates with the exhaust vent 122 provided adjacent the front end of the plunger as shown in FIG. 2a, and a spring 154 disposed in a hollow part 153b of the ball seat 153. The spring 154 biases the check ball 151 away from the seat and toward the high pressure oil chamber, i.e., in a direction opposite to the flow of air being exhausted through vent hole 153a. The end of the spring-accommodating hollow part 153b of the ball seat is flared so that the check ball 151 contacts a flared surface when seated.

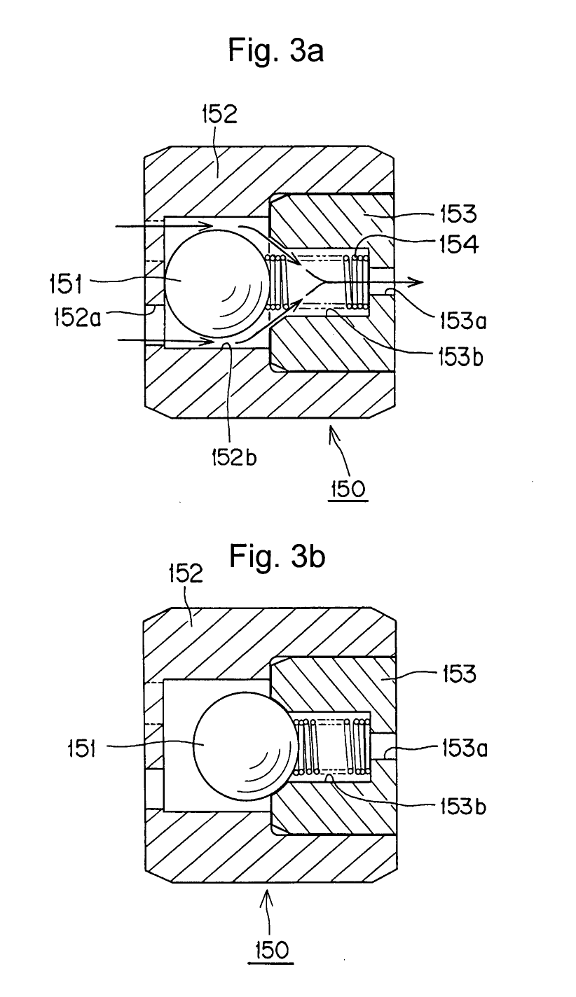

When air is mixed with the oil in the high pressure oil chamber R at the time the engine equipped with the tensioner is started, the pressure in the chamber R cannot rise to a level sufficient to maintain the check ball 151 in contact with its seat against the biasing force exerted by spring 154. Thus, the check valve remains in an open condition, allowing air to escape through a gap between the check ball 151 and the ball seat 153 as shown in FIG. 3a. On the other hand, when the air is exhausted from the high pressure oil chamber R, and the chamber becomes filled with oil, the flow of oil causes the ball to move toward the seat as shown in FIG. 3b, and the pressure in the high pressure oil chamber R can increase to a level such that it exerts a force on the ball 151 that overcomes the biasing force exerted by spring 154. As a result the ball 151 is held in a seated condition as shown in FIG. 3b, closing off the flow of oil through vent hole 153a, and allowing pressure to be maintained within the high pressure oil chamber without outflow of oil.

In the assembly of the tensioner, the cylindrical ball seat 153 is fitted to the metal retainer 152, and the retainer 152 is then fitted into the hole 121 in the plunger as shown in FIG. 2a. The deairing valve assembly is capable of operating reliably over a long time under the conditions of high pressure and temperature within the tensioner.

The front end of the plunger-biasing spring 130 (FIG. 2a) reliably abuts the end surface 152c (FIG. 2b) of the retainer 152, and the plunger biasing spring 130 expands and contracts smoothly within the hole 121 in the plunger as the plunger slides out of and into the plunger-receiving hole 111 in the tensioner body. Wear and contact noise due to abnormal contact between the plunger-biasing spring and the the plunger can be avoided.

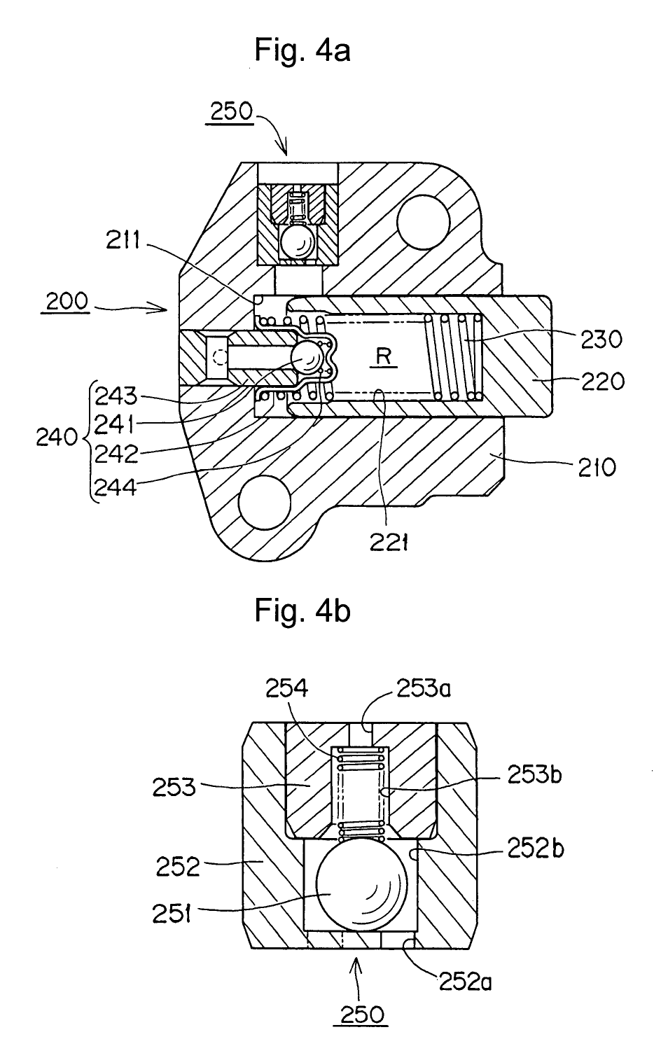

In the embodiment shown in FIG. 4a, a deairing type hydraulic tensioner 200 comprises a hollow cylindrical plunger 220 slidable in a plunger-receiving hole 211 formed in a tensioner body 210. A high pressure oil chamber R is formed by the plunger-receiving hole 211 and a hole 221 formed in the plunger. The high pressure oil chamber R accommodates a plunger-biasing spring 230, which biases the plunger 220 in the protruding direction.

A check valve assembly 240 is incorporated into the bottom of the plunger-receiving hole 211. The check valve assembly allows oil to flow into the high pressure oil chamber R but blocks reverse flow of oil from the high pressure oil chamber.

The check valve assembly 240 comprises a check ball 241, a metal retainer 242, which envelops the check ball, allowing the ball to move freely with in a limited range into and out of engagement with a cylindrical metal seat 243, which is fitted to the tensioner body and which has a passage for flow of oil into the high pressure oil chamber R from an oil supply. A biasing spring 244 biases the check ball 241 toward the ball seat 243. The check valve assembly 240 allows oil to flow into the high pressure oil chamber R from a source of oil under pressure, but blocks reverse flow of oil.

In the embodiment shown in FIG. 4a, a deairing check valve assembly 250 is incorporated into the tensioner body rather than into the plunger. The deairing check valve assembly is positioned near the bottom of the plunger-receiving hole, at a location such that flow of air through the deairing check valve is not blocked by the plunger itself.

As shown in FIG. 4b, deairing check valve assembly 250o comprises check ball 251, which blocks outflow of oil from the high pressure oil chamber, a cylindrical metal seat 253, and a metal retainer 252, which envelops the check ball 251, allowing the check ball to move freely within a limited range toward and away from the seat in a guide hole 252b in the retainer. The seat 253 is fitted in a recess formed in the retainer 252. The seat has a vent hole 253a, which communicates with the exterior of the tensioner. A spring 254 is disposed in a hollow part 253b of the ball seat 253. The spring 254 biases the check ball 251 away from the seat and toward the high pressure oil chamber, i.e., in a direction opposite to the flow of air being exhausted to the exterior of the tensioner. The end of the spring-accommodating hollow part 253b of the ball seat is flared so that the check ball 251 contacts a flared surface when seated.

When air is mixed with the oil in the high pressure oil chamber R at the time the engine equipped with the tensioner is started, the pressure in the chamber R cannot rise to a level sufficient to maintain the check ball 251 in contact with its seat against the biasing force exerted by spring 254. Thus, the check valve remains in an open condition, allowing air to escape through a gap between the check ball 251 and the ball seat 253. On the other hand, when the air is exhausted from the high pressure oil chamber R, and the chamber becomes filled with oil, the flow of oil causes the ball to move toward the seat, and the pressure in the high pressure oil chamber R can increase to a level such that it exerts a force on the ball 251 that overcomes the biasing force exerted by spring 254. As a result the ball 251 is held in a seated condition, closing off the flow of oil through vent hole 253a, and allowing pressure to be maintained within the high pressure oil chamber without outflow of oil.

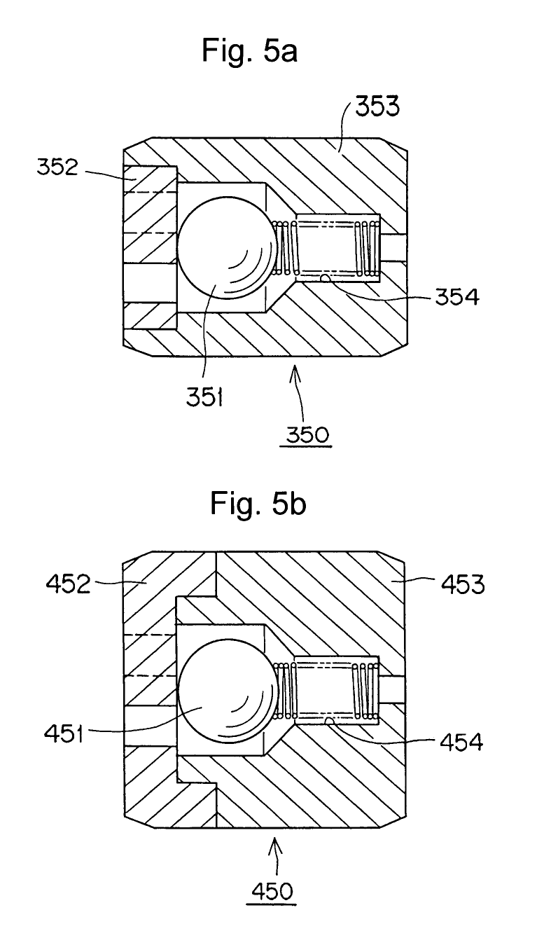

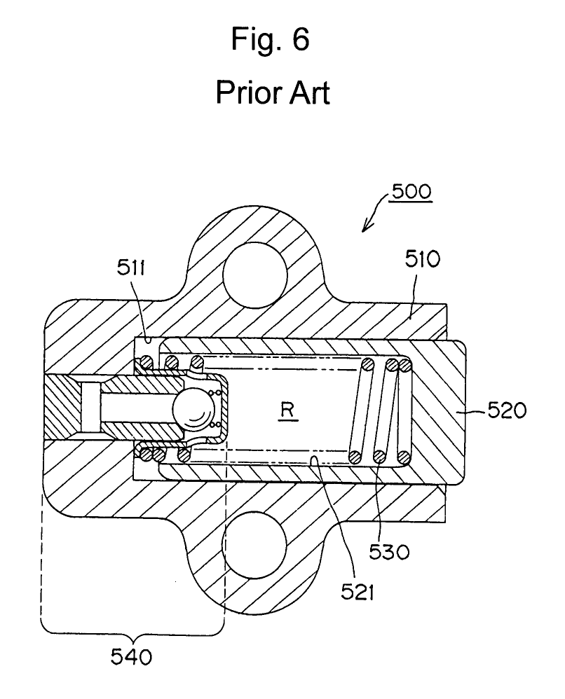

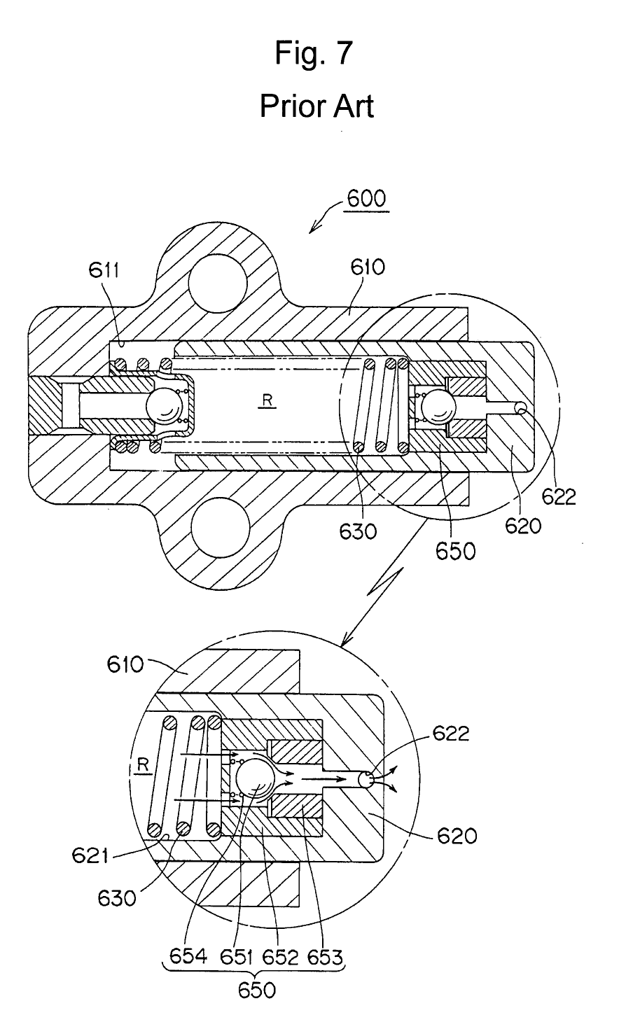

Although, in the deairing check valve assemblies 150 and 250, the cylindrical ball seats 153 and 253 are press-fit into retainers 152 and 252 respectively, the deairing ball assembly can have an alternative configuration in which the retainer is press-fit into a ball seat. Thus, in the deairing check valve assembly 350 shown in FIG. 5a, a check ball 351 is movable within a space formed in a seat 353 toward and away from a seated condition, biased by a spring 354, and retained in its space by a retainer 352 which is press-fit into a recess formed in the seat. In the deairing check valve assembly 450 shown in FIG. 5b, the check ball 451 is movable within a space formed in a seat 453 toward and away from a seated condition, biased by a spring 454, and retained in its space by a retainer 452 formed with a recess into which a boss formed on the seat is press-fit.

In summary, according to the invention, a check ball biasing spring is provided on the discharge side of the ball, urging the ball away from its seat and toward the high pressure oil chamber of the tensioner. Discharge of air from the high pressure oil chamber is dramatically improved, and, as a result, backlash and vibration of a timing chain are suppressed, and unusual noises are prevented. Furthermore, since the deairing check valve can be preassembled before it is installed in the plunger or in the tensioner body, manufacture of the deairing type tensioner is facilitated. The performance of the hydraulic tensioner can be determined by selection of a ball-biasing spring having a desired biasing force.

We claim:

1. A deairing type hydraulic tensioner comprising a tensioner body having a plunger-receiving hole formed therein said plunger-receiving hole having an open end and a bottom; a plunger slidably received in said plunger-receiving hole and protruding therefrom through said open end in a protruding direction, the plunger having a hollow interior and having an open end facing said bottom, and a plunger bottom opposite from said open end, said hollow interior of the plunger and said plunger-receiving hole in the tensioner body together forming a high pressure oil chamber; a biasing spring urging the plunger in the protruding direction; and a deairing check valve assembly for exhausting air mixed with oil in said high pressure oil chamber to the exterior of said tensioner by flow in an outward direction; wherein the deairing check valve assembly comprises a check ball; a ball seat having a hollow flow passage, the ball being engageable with the ball seat, by movement along said outward direction, to close the flow passage and thereby block outward flow of oil from said high pressure oil chamber; a retainer, fitted to the ball seat, for limiting movement of the ball toward and away from the ball seat; a vent hole in the ball seat at an end thereof remote from said ball; and a biasing spring, disposed with the flow passage of the ball seat between the vent hole and the ball and engaged with the ball, the biasing spring urging the check ball away from the ball seat.

2. A deairing type hydraulic tensioner according to claim 1, having an exhaust vent for release of air from the high pressure oil chamber the exhaust vent being provided in the plunger adjacent the plunger bottom; in which the deairing check valve assembly is incorporated into the interior of the plunger adjacent said plunger bottom; and in which the vent hole in the ball seat is in communication with the exhaust vent.

3. A deairing type hydraulic tensioner according to claim 1, in which said deairing check valve assembly is incorporated into the tensioner body.
